(19) United States
(12) Patent Application Publication
(10) Pub. No.: US 2017/0286061 A1
(43) Pub. Date: Oct. 5, 2017

(54) INFORMATION PROCESSING TERMINAL AND INFORMATION PROCESSING METHOD

(71) Applicant: KYOCERA CORPORATION, Kyoto (JP)

(72) Inventors: Naoyuki TAMAI, Yokohama-shi (JP); Tomohiro SHIMAZU, Yokohama-shi (JP)

(21) Appl. No.: 15/629,514

(22) Filed: Jun. 21, 2017

Related U.S. Application Data
(63) Continuation of application No. PCT/JP2015/086366, filed on Dec. 25, 2015.

(30) Foreign Application Priority Data
Dec. 25, 2014 (JP) 2014-261805

(51) Int. Cl. G06F 3/16; H04B 1/3827; G06F 3/0484; G06F 3/0489; G06F 3/0488; G10L 17/22

(52) U.S. Cl. CPC G06F 3/167; G06F 3/04886; G10L 17/22; G06F 3/04842; G06F 3/0489; H04B 1/3833

(57) ABSTRACT

An information processing terminal of one embodiment is configured to set at least one of a first operation mode and a second operation mode as an operation mode. The information processing terminal includes a microphone, a touchscreen and at least one processor. The at least one processor is configured to execute a function of a touchable object displayed on the touchscreen when the touchable object is operated by a user in the first operation mode. The at least one processor is configured to execute the function of the touchable object when a voice input through the microphone indicates the touchable object in the second operation mode.

### CROSS-REFERENCE TO RELATED APPLICATION

The present application is a continuation based on PCT Application No. PCT/JP2015/086366 filed on Dec. 25, 2015, which claims the benefit of Japanese Application No. 2014-261805, filed on Dec. 25, 2014. PCT Application No. PCT/JP2015/086366 is entitled “Touchscreen-Equipped Information Processing Terminal and Information Processing Method”, and Japanese Application No. 2014-261805 is entitled “Touchscreen-Equipped Information Processing Terminal and Information Processing Method and Information Processing Program”. The contents of which are incorporated by reference herein in their entirety.

### FIELD

Embodiments of the present disclosure relate to an information processing terminal including a touchscreen and an information processing method, and more particularly to a new information processing terminal and a new information processing method for operating by voice an object (including a tile or an icon, a virtual (soft) key, and the like) which is displayed on a touchscreen, for example, and which can be operated by a touch input.

### BACKGROUND

As a background technique, a mobile phone is known which, upon receipt of an e-mail message, reads the e-mail message aloud when “read aloud” is input by voice. This background technique is not a technique for operating an object by voice.

A function by which a request can be made to a mobile phone by voice is known. When an instruction is input by voice, the mobile phone interprets the voice instruction, executes a necessary operation, and supplies a desired result to a user.

### SUMMARY

An aspect is an information processing terminal configured to set at least one of a first operation mode and a second operation mode as an operation mode. The information processing terminal includes a microphone, a touchscreen and at least one processor. The at least one processor is configured to execute a function of a touchable object displayed on the touchscreen when the touchable object is operated by a user in the first operation mode. The at least one processor is configured to execute the function of the touchable object when a voice input through the microphone indicates the touchable object in the second operation mode.

Another aspect is an information processing method executed by a processor included in an information processing terminal configured to set at least one of a first operation mode and a second operation mode as an operation mode. The information processing terminal includes a microphone, a touchscreen and at least one processor. The at least one processor is configured to execute a function of a touchable object displayed on the touchscreen when the touchable object is operated by a user in the first operation mode. In the second operation mode, the information processing method includes recognizing a voice input through the microphone, determining whether the voice indicates the touchable object, and executing the function of the touchable object when it is determined that the voice indicates the touchable object.

Still another aspect is a processor-readable non-transitory recording medium with a program recorded thereon, the program causing a processor to execute an information processing method, the processor being included in an information processing terminal configured to set at least one of a first operation mode and a second operation mode as an operation mode. The information processing terminal includes a microphone, a touchscreen and at least one processor. The at least one processor is configured to execute a function of a touchable object displayed on the touchscreen when the touchable object is operated by a user in the first operation mode. In the second operation mode, the information processing method includes recognizing a voice input through the microphone, determining whether the voice indicates the touchable object, and executing the function of the touchable object when it is determined that the voice indicates the touchable object.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is an outline view showing an example of a mobile phone of one embodiment of the present disclosure.

FIG. 2 is a block diagram showing an example of an electric configuration of the mobile phone shown in FIG. 1.

FIG. 3 is a schematic view showing an example of a lock screen displayed on a touchscreen.

FIG. 4 is a schematic view showing an example of a home screen displayed on the touchscreen.

FIG. 5 is a schematic view showing an example of a contact screen displayed on the touchscreen.

FIG. 6 is a schematic view showing a next example of the contact screen displayed on the touchscreen.

FIG. 7 is a schematic view showing an example of a calling screen displayed on the touchscreen.

FIG. 8 is a schematic view showing an example of a memory map of a RAM shown in FIG. 2.

FIG. 9 is a drawing showing an example of a flow showing an unlock operation in the mobile phone shown in FIG. 1.

FIG. 10 is a drawing showing an example of a flow showing an operation on the home screen in the mobile phone shown in FIG. 1.

FIG. 11 is a drawing showing an example of a flow showing an operation on an application screen in the mobile phone shown in FIG. 1.

FIG. 12 is a schematic view showing another example of the home screen displayed on the touchscreen.

FIG. 13 is a schematic view showing another example of the application screen displayed on the touchscreen.

### DETAILED DESCRIPTION

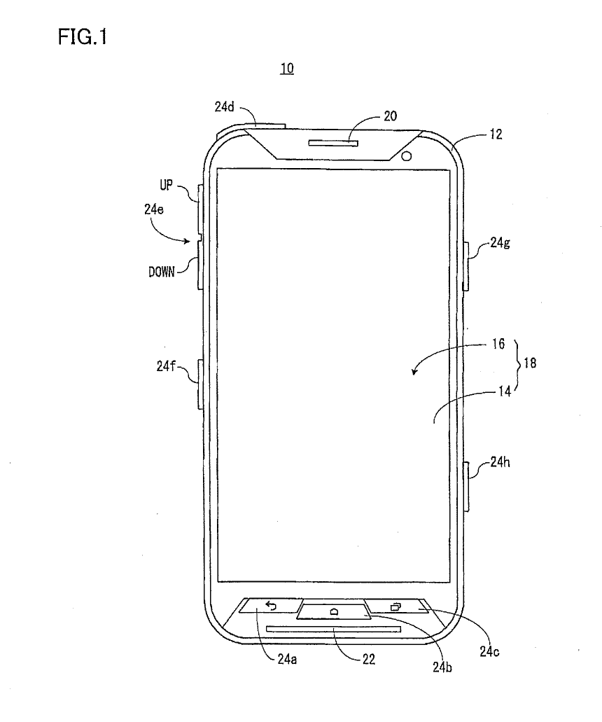

Referring to FIG. 1, a mobile phone 10 of one embodiment of the present disclosure is a smartphone as an example. Mobile phone 10 may be possessed by a user. It is pointed out in advance that the present disclosure is applicable not only to mobile phone 10 but also to any information processing terminal including a touchscreen, such as a desktop PC (Personal Computer), a laptop PC, a tablet type PC, a tablet terminal, and a PDA (Personal Data Assistant).

As shown in FIG. 1, mobile phone 10 can include a vertically-long flat rectangular housing 12, for example. A display 14 can be located on a main surface (front surface) of housing 12. Display 14 can be implemented by a liquid crystal display, an organic EL (Electro Luminescence) display or the like, for example. A touch panel 16 can be located on display 14, for example. In this specification, these display 14 and touch panel 16 are collectively called a “touchscreen 18” although they may be referred to individually. On touchscreen 18, an object being displayed can be operated by a touch input. Display 14 and touch panel 16 may be separate components, or may be an integral component.

A speaker 20 is built in one end (upper end) in the longitudinal direction of housing 12, and a microphone 22 is built in the other end (lower end) in the longitudinal direction on the main surface side. Hardware keys (hereinafter briefly called “keys”) 24a, 24b, 24c, 24d, 24e, 24f, 24g, and 24h functioning as an input unit or an operation unit together with touchscreen 18 can be located on the main surface and side surfaces of housing 12.

As understood from FIG. 1, keys 24a, 24b and 24c can be located side by side on the main surface of housing 12 and on the lower side of touchscreen 18. Key 24d can be located at the left end of the top (upper side surface) of housing 12. Keys 24e and 24f can be located on the left side surface of housing 12.

As understood from FIG. 1, on the left side surface of housing 12, key 24e can be located at the upper end, and key 24f can be located at the center. Keys 24g and 24h can be located on the right side surface of housing 12.

As understood from FIG. 1, on the right side surface of housing 12, key 24g can be located at a slightly upper position from the center, and key 24h can be located at a slightly lower position from the center.

The arrangement and number of keys 24a to 24h here indicate an example, and are not necessarily limited to the configuration of mobile phone 10 of an embodiment. Appropriate modification can be made. Functions assigned to keys 24a to 24h which will be described later also indicate an example, and should not be limited to them. Appropriate modification can be made depending on actual product specifications.

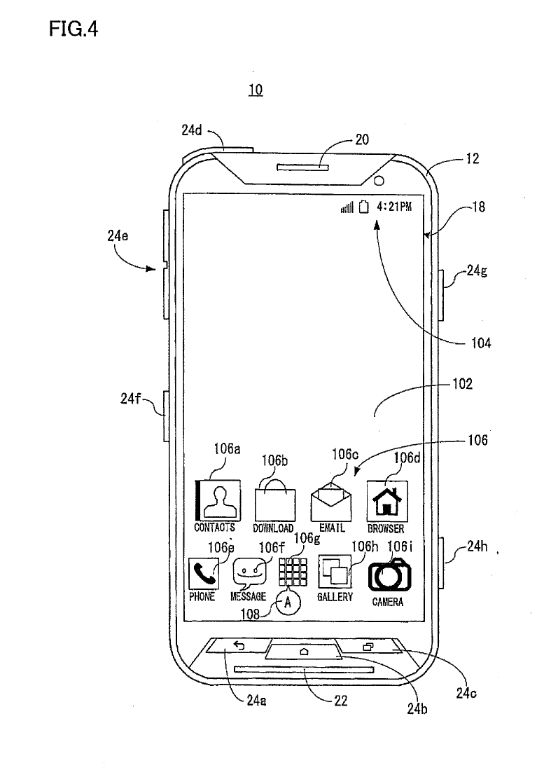

Key 24a is a back key, which can be used for displaying (returning to) an immediately preceding screen. Key 24b is a home key, which can be used for displaying a home screen (see FIG. 4). Key 24c is a menu key, which can be used for displaying a menu about options for a screen currently displayed.

Key 24d is a switch key for speaker 20, which can be used for switching between a receiving speaker and a handsfree speaker. In an embodiment, speaker 20 serves both as the receiving speaker and the handsfree speaker. The sound volume of speaker 20 can be switched between the sound volume for receiving purpose and the sound volume for handsfree purpose by adjusting the gain of speaker 20.

Key 24e is a volume key, which can be used for adjusting the sound volume. This key 24e can include an UP key and a DOWN key. When the UP key is operated, the sound volume can be increased. When the DOWN key is operated, the sound volume can be decreased. The sound volume can be adjusted between the maximum and minimum values. Key 24e is a seesaw key or a locker key, and may also be used for another application which requires adjustments for increase and decrease.

Key 24f is a PTT (Push-To-Talk) talk key, which can be used for speaking (uttering) in a PTT phone call.

Key 24g is a power key, which can be used for turning on/off the main power supply of mobile phone 10. Key 24h is a camera key, which can be used for executing a camera function (camera application).

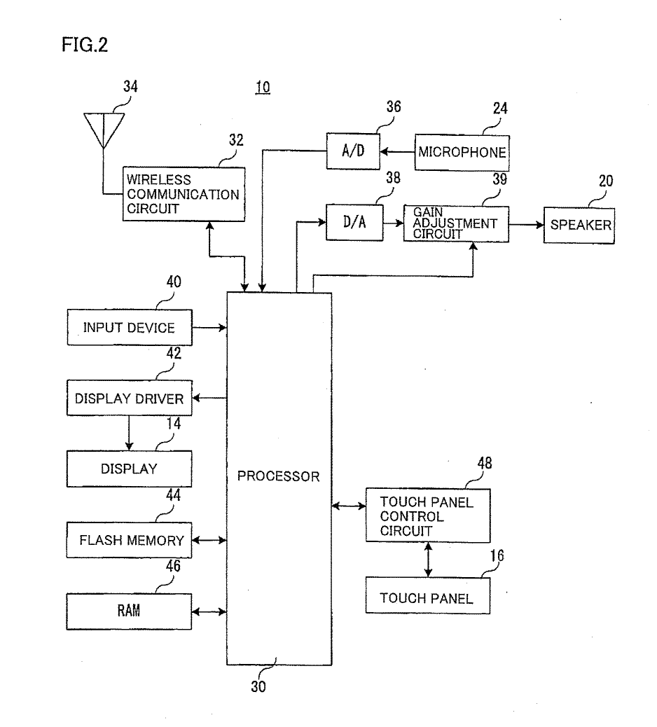

FIG. 2 is a block diagram showing an example of an electric configuration of mobile phone 10 shown in FIG. 1. As shown in FIG. 2, mobile phone 10 includes at least one processor 30 for providing control and processing capability to perform various functions as described in further detail below. In accordance with various embodiments, at least one processor 30 may be implemented as a single integrated circuit (IC) or as multiple communicatively coupled ICs and/or discrete circuits. It is appreciated that at least one processor 30 can be implemented in accordance with various known technologies. In one embodiment, the processor includes one or more circuits or units configurable to perform one or more data computing procedures or processes by executing instructions stored in an associated memory, for example. In other embodiments, at least one processor 30 may be implemented as firmware (e.g. discrete logic components) configured to perform one or more data computing procedures or processes. In accordance with various embodiments, at least one processor 30 may include one or more processors, controllers, microprocessors, microcontrollers, application specific integrated circuits (ASICs), digital signal processors, programmable logic devices, field programmable gate arrays, or any combination of these devices or structures, or other known devices and structures, to perform the functions described herein. At least one processor 30 includes a CPU (Central Processing Unit) and may be called a computer, for example. At least one processor 30 includes a storage element. The storage element is a SRAM (Static Random Access Memory) or a DRAM (Dynamic Random Access Memory), for example. Processor 30 can manage overall control of mobile phone 10. A wireless communication circuit 32, an A/D (Analog/Digital) converter 36, a D/A (Digital/Analog) converter 38, a gain adjustment circuit 39, an input device 40, a display driver 42, a flash memory 44, a RAM (Random Access Memory) 46, a touch panel control circuit 48, and the like are connected to processor 30.

An antenna 34 can be connected to wireless communication circuit 32. A microphone 24 can be connected to A/D converter 36. Speaker 20 can be connected to D/A converter 38 with gain adjustment circuit 39 located therebetween. Display 14 can be connected to display driver 42. Touch panel 16 can be connected to touch panel control circuit 48.

Flash memory 44 functions as a storage. Flash memory 44 can store a control program for mobile phone 10 and various types of data necessary for execution of the control program. RAM 46 functions as a storage. RAM 46 can be used as a working area or a buffer area of processor 30. All or part of the control program stored in flash memory 44 can be developed to (written into) RAM 46 when in use. Processor 30 can operate in accordance with the control program on this RAM 46. RAM 46 can also store data necessary for execution of the control program. The control program may be read into RAM 46 from a processor-readable storage medium different from mobile phone 10, such as, for example, an SD (Secure Digital) card or a USB (Universal Serial Bus) memory.

Input device 40 includes keys 24a to 24h shown in FIG. 1, and can receive a key operation on each of keys 24a to 24h. Information (key data) on any of keys 24a to 24h for which a key operation has been received may be input to processor 30 by input device 40. Input device 40 also includes a virtual key (software key) displayed on touchscreen 18, such as a numerical keypad and alphabet keys. In various embodiments, input device 40 may be implemented using any input technology or device known in the art such as, for example, a QWERTY keyboard, a pointing device (e.g., a mouse), a joy stick, a stylus, a touchscreen display panel, a key pad, one or more buttons, etc., or any combination of these technologies.

Wireless communication circuit 32 includes a circuit for transmitting and receiving electric waves for a voice call or e-mail via antenna 34. In an embodiment, wireless communication circuit 32 includes a circuit for making wireless communications by the CDMA (Code Division Multiple Access) technology. For example, based on an operation for call origination (voice transmission) received by touchscreen 18, wireless communication circuit 32 can execute a voice transmission process under an instruction from processor 30, and can output a voice transmission signal via antenna 34. The voice transmission signal can be transmitted to the other party's phone through a base station and a communication network. When a voice arrival process is performed in the other party's phone, a state where a communication can be made is established, and processor 30 can execute a calling process. Wireless communication circuit 32 may support another communication system, such as the LTE (Long Term Evolution) system, rather than the CDMA system.

A/D converter 36 can convert an analog audio signal obtained from microphone 22 into digital audio data, and can input the audio data to processor 30. D/A converter 38 can convert digital audio data into an analog audio signal, and can supply the signal to speaker 20 via gain adjustment circuit 39. Voice based on the audio data can be output from speaker 20. With a calling process being executed, voice collected by microphone 22 can be transmitted to the other party's phone, and voice collected at the other party's phone can be output from speaker 20.

The sound volume of speaker 20 can be adjusted by gain adjustment circuit 39. In response to an operation on key 24d, gain adjustment circuit 39 can switch between the sound volume (sound pressure level) for receiving purpose and the sound volume (sound pressure level) for handsfree purpose under an instruction from processor 30. In response to an operation on key 24e, gain adjustment circuit 39 can change the sound volume within a control range of the sound volume for receiving purpose, and can change the sound volume within a control range of the sound volume for handsfree purpose.

Display 14 (touchscreen 18) can display video or an image in accordance with video data or image data output from processor 30. For example, display driver 42 includes a video memory temporarily storing video data or image data to be displayed on display 14 (touchscreen 18). The video data or image data output from processor 30 can be stored in this video memory. Display driver 42 can cause display 14 (touchscreen 18) to display video or an image in accordance with the contents of the video memory. Display driver 42 can control display 14 (touchscreen 18) connected to display driver 42 under an instruction from processor 30.

Touch panel control circuit 48 can apply a voltage or the like necessary for touch panel 16 (touchscreen 18), and can input coordinate data indicating a position touched by a finger or stylus (touched position) to processor 30. Processor 30 can determine a touched object based on the input coordinate data. In this specification, an object refers to any GUI (Graphical User Interface) that can be operated by a touch input including an icon, tile, software key (virtual key), still image, character, number, character string, and the like, displayed on touchscreen 18.

With a function by which a request can be made to mobile phone 10 by voice, a desired result can be obtained even if a user does not operate mobile phone 10 directly, which is convenient, For example, when an instruction is input by voice, such as “Call Mr. Ichiro Yamada”, mobile phone 10 can interpret the voice instruction, execute a necessary operation, and supply a desired result to a user.

For example, in the above-mentioned example, when a registered name in the telephone directory is not “Ichiro Yamada” but “Mr. Yamada” with his first name omitted, the result may be that mobile phone 10 cannot find “Ichiro Yamada” included in the instructing voice in the telephone directory, or respond to the instruction after all. Without a voice input that can be understood by mobile phone 10, it may be impossible to make a reliable operation.

In an embodiment in which a touchable object displayed on touchscreen 18 can be operated by a voice input, an object can be reliably operated similarly to the case of operating a touchable object by a touch input.

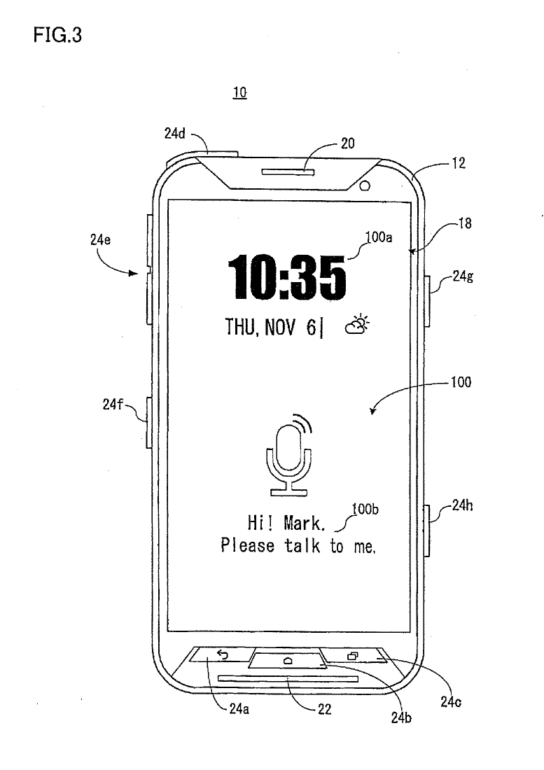

FIG. 3 shows, an example of a lock screen 100. When power key 24g is operated with a locked state (in which an operation other than that on power key 24g is not accepted) being set, lock screen 100 may be displayed on touchscreen 18.

On lock screen 100, when a touch operation conforming to a preset pattern (locus) is performed on touchscreen 18, for example, as is well known, the locked state may be cancelled to cause a home screen to be displayed as shown in FIG. 4.

For example, it may be quite difficult for one to perform a touch operation conforming to a specific pattern while wearing a dirty glove at a work site or the like. In an embodiment of the present disclosure, the locked state can be cancelled by a voice input in such a case. For that purpose, a voice input instructing section 100b can be displayed on this lock screen 100 in addition to a status display section 100a. In accordance with an instruction by voice input instructing section 100b, a user can make a voice input.

To cancel the locked state by a voice input, a specific key may be pressed first, as will be described later in detail. In an embodiment, the specific key includes speaker switch key 24d on the upper left. When a voice determined in advance is input through microphone 22 with speaker switch key 24d being pressed, the locked state can be cancelled. The voice determined in advance in an embodiment includes “Smart Device.” A user can cancel the locked state by a touch operation or a voice operation depending on a situation.

FIG. 4 is a schematic view showing an example of a home screen 102 displayed on touchscreen 18. Home screen 102 can include a status display section 104 and a function display section 106. A pictogram indicating an electric-wave receiving state through antenna 34, a pictogram indicating a battery capacity of a secondary battery, and the time can be displayed in status display section 104. Objects, such as icons or tiles displaying functions, can be displayed in function display section 106.

An object 106a includes a shortcut object for executing a contact book function in which all of persons who are accessible by phone, e-mail or the like are registered. In an embodiment, object 106a may be accompanied by a readable word (characters that a user can read and pronounce) “CONTACTS” (meaning “contact address”). When a user wishes to indicate object 106a by voice, he/she only needs to pronounce “CONTACTS.”

An object 106b includes a shortcut object for obtaining contents (video, music, data, or the like) by downloading. In an embodiment, object 106b may be accompanied by a readable word “DOWNLOAD.” When a user wishes to indicate object 106b by voice, he/she only needs to pronounce “download.”

An object 106c includes a shortcut object for executing a function of sending an email message. In an embodiment, object 106c may be accompanied by a readable word “EMAIL.” When a user wishes to indicate object 106c by voice, he/she only needs to pronounce “email.”

An object 106d includes a shortcut object for executing a function of accessing a URL (Uniform Resource Locator) using the Internet, for example. In an embodiment, object 106d may be accompanied by a readable word “BROWSER.” When a user wishes to indicate object 106d by voice, he/she only needs to pronounce “browser.”

An object 106e includes a shortcut object for executing a telephone directory function unlike above-described CONTACTS object 106a. In an embodiment, object 106e may be accompanied by a readable word “PHONE.” When a user wishes to indicate object 106e by voice, he/she only needs to pronounce “phone.”

An object 106f includes a shortcut object for executing a message transmission function. In an embodiment, object 106f may be accompanied by a readable word “MESSAGE.” The message includes SNS (Social Networking Service), such as Twitter® and Facebook®, for example. When a user wishes to indicate object 106f by voice, he/she only needs to pronounce “message.”

An object 106g includes a shortcut object for selecting another menu or a submenu. Objects 106a to 106f described above and objects 106h and 106i which will be described later may be originally accompanied by readable words. When a user is going to indicate objects 106a to 106f, 106h and 106i by voice to use them, he/she can easily pronounce looking at their readable words.

Object 106g for executing a menu selection function of selecting another application may not be accompanied by a readable word. When a user is going to indicate object 106g by a voice input, he/she may be unable to read and input a suitable voice for object 106g. When various voices are input for object 106g, object 106g cannot necessarily be indicated properly.

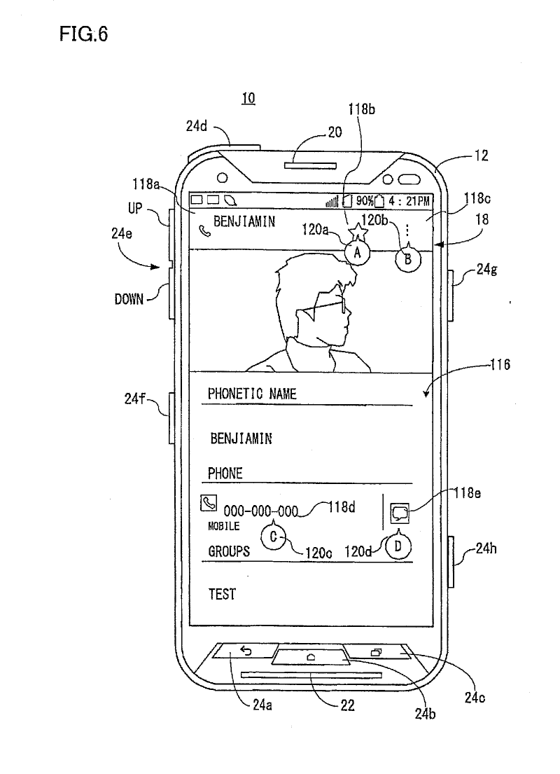

In an embodiment, an object may be accompanied by a readable mark 108 prepared separately in a case where the object is not accompanied by a readable word, in a case where even though there is a readable word, such as a telephone number as will be described later (FIG. 6), a character string thereof is too long and unsuitable for a voice input, or in a case where reading aloud in public may invade someone's privacy.

In an embodiment, menu object 106g may be accompanied by readable mark 108 including “A” which is a readable character. When a user wishes to indicate object 106g by voice, he/she only needs to pronounce “A”.

Object 106h includes a shortcut object for executing a function for looking at a picture. In an embodiment, object 106h may be accompanied by a readable word “GALLERY.” When a user wishes to indicate object 106h by voice, he/she only needs to pronounce “gallery.”

Object 106i includes an object for executing a camera function. Since the camera function is assigned to key 24h fixedly, key 24h may be pressed for executing the camera function.

The camera function can also be indicated by voice. Object 106i for executing the camera function may be accompanied by a readable word “CAMERA.” When a user wishes to indicate object 106i by voice, he/she only needs to pronounce “camera.”

Objects 106a to 106i shown in FIG. 4 may be displayed on touchscreen 18. Any object can be specified by a touch input similarly to a conventional mobile phone. In an embodiment, each object can be accompanied by a readable word such that each of touchable objects 106a to 106i can also be specified by a voice input. An object with no readable word can be accompanied by readable mark 108.

When any of objects 106a to 106i is selected on home screen 102 as described above, the display of touchscreen 18 can transition to an application screen for executing a specific application indicated by the selected object.

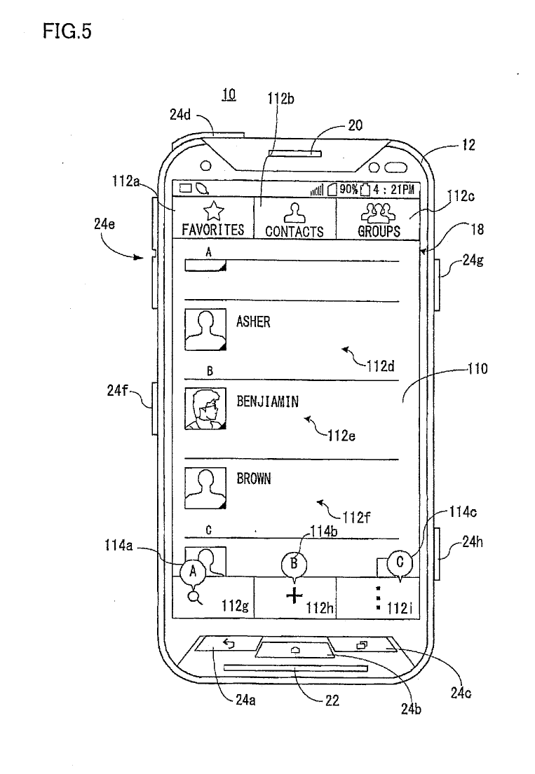

FIG. 5 illustrates an application screen when object 106a representing the CONTACTS function has been selected by a touch input or a voice input on home screen 102 in FIG. 4. FIG. 5 shows an example of a contact screen 110 displayed on touchscreen 18 in the CONTACTS application. Objects 112a, 112b and 112c can be displayed on the upper side of contact screen 110.

Object 112a includes an object for calling a registered favorite. Object 112a can be accompanied by a readable word “FAVORITES.” When a user wishes to indicate object 112a by voice, he/she only needs to pronounce “FAVORITES.”

Object 112b includes an object for executing the CONTACTS function similarly to object 106a in FIG. 4. Object 112b can be accompanied by a readable word “CONTACTS.” When a user wishes to indicate object 112b by voice, he/she only needs to pronounce “CONTACTS.”

Object 112c includes an object for calling a group registered as contact addresses. Object 112c can be accompanied by a readable word “GROUP.” When a user wishes to indicate object 112c by voice, he/she only needs to pronounce “group.”

On contact functional screen 110, registered information may be displayed on touchscreen 18 in the alphabetical order, “A”, “B”, “C” . . . in an embodiment. In an embodiment, an object 112d indicating “ASHER” as the name of a contact address can be displayed in the section “A”. When a user wishes to call the contact address of this registered name, object 112d can be selected by touching object 112d. The user can also specify object 112d by a voice input. The user only needs to pronounce “ASHER.”

Object 112e indicating “BENJIAMIN” as the name of a contact is displayed in the section “B”. When the user wishes to call the contact address of this registered name, object 112e can be selected by touching object 112e. The user can also specify object 112e by a voice input. In that case, the user only needs to pronounce “BENJIAMIN.”

Object 112d indicating “BROWN” as the name of a contact address is displayed in the section “B”. When the user wishes to call the contact address of this registered name, object 112d can be selected by touching object 112d. The user can also specify object 112d by a voice input. In that case, the user only needs to pronounce “BROWN.”

On contact functional screen 110, registered information may be displayed for each column of the Japanese syllabary.

An object 112g accompanied by a symbol meaning “search”, an object 112h accompanied by a symbol “+”, and an object 112i accompanied by a symbol “. . . ” for calling a submenu can be displayed under these registered names on contact screen 110. Objects 112g to 112i can also be selected or specified by a touch input.

When a user wishes to indicate objects 112g, 112h and 112i by a voice input, he/she does not know how to read objects 112g to 112i because they are not accompanied by readable words. It is also anticipated that a correct voice input cannot be made.

In an embodiment, objects 112g, 112h and 112i can be accompanied by corresponding readable marks 114a, 114b and 114c each having an easy readable word similarly to object 106g on home screen 102 in FIG. 4. When a user wishes to indicate any of objects 112g to 112i by voice, a voice input can be made by reading out a corresponding readable mark among accompanying readable marks 114a to 114c.

FIG. 6 shows an example of an application screen 116 displayed on touchscreen 18 after indicating object 112 by a touch input or a voice input on application screen 110 in FIG. 5. In this example, a picture of a person called “BENJIAMIN” is displayed, and an object 118a for calling the registration of the person called “BENJIAMIN” in the telephone directory, an object 118b accompanied by a symbol (star) indicating a favorite, and an object 118c accompanied by a symbol “ . . . ” can be displayed above the picture. Since objects 118a to 118c include touchable objects, each of them can be specified by a touch input.

When indicating objects 118a to 118c by a voice input, a correct voice input may be unable to be made because how to pronounce them is unknown except for object 118a.

In an embodiment, objects 118b and 118c may be displayed with readable marks 120a and 120b, respectively.

Since the picture of the person called “BENJIAMIN” is not an object that can be specified or selected by a touch input, the picture may not be accompanied by a readable mark.

A “Phonetic Name” indicating pronunciation may be displayed below the picture. Since the phonetic name is not an object that should be specified by a touch input, the phonetic name may not be accompanied by a readable mark.

The telephone number of “BENJIAMIN” can be displayed as an object 118d below the phonetic name on touchscreen 18. An object 118e indicating SMS (Short Message Service) is displayed next to object 118d. Objects 118d and 118e can each be specified by a touch input.

A character string indicating a telephone number can be displayed as object 118d indicating the telephone number. By reading out the telephone number, a voice input can also be made. Since the telephone number has a large number of digits, it may require time for reading aloud. Reading a telephone number aloud at a place where other persons are present may also invade privacy. Reading a telephone number aloud may be inconvenient. In an embodiment, object 118d indicating a telephone number can be accompanied by a readable mark 120c. In an embodiment, even in a case of an object accompanied by a readable word, when it is supposed that inconvenience will arise by reading out the readable word, another readable mark can be prepared, and an object accompanied by the readable mark can be displayed.

Since pronunciation of SMS object 118e is unknown, object 118e can be accompanied by another readable mark 120d.

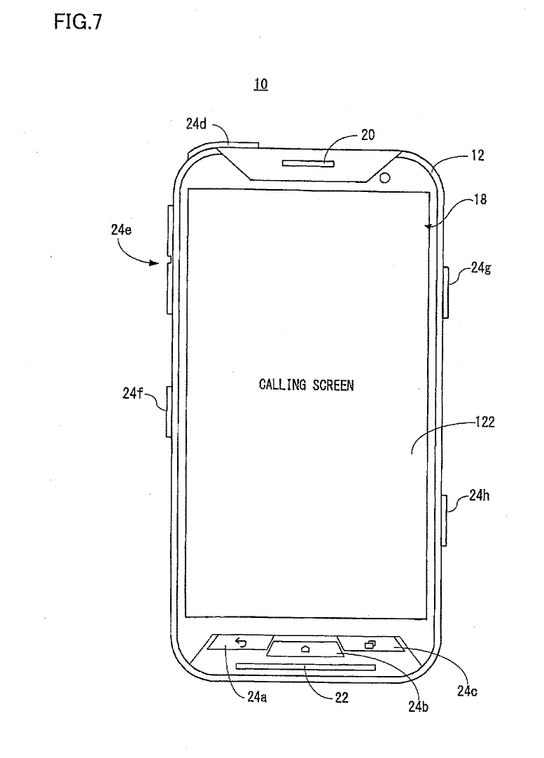

When object 118d is specified by a touch input or a voice input on application screen 116 in FIG. 6, it means that the telephone number has been specified. In this case, the display on touchscreen 18 can transition to a calling screen 122 shown in FIG. 7.

As understood from FIGS. 4 to 6, the readable marks added on each display screen can be updated for each screen as indicated by “A”, “B”, “C” . . . , for example. By allowing the same readable marks to be used on each screen, the number of readable marks to be prepared in advance can be reduced. Processor 30 can determine which object is accompanied by which readable mark on each display screen. Processor 30 can exactly determine which object is indicated by a voice input from a user on the screen currently displayed.

Different readable marks may be used on each screen. Readable marks of any form can be used.

Readable marks are not limited to the alphabets, such as “A”, “B”, “C” . . . , but may be numbers that can be input by a user by voice, for example. A readable mark is not limited to one letter, but may be a character string including a plurality of letters.

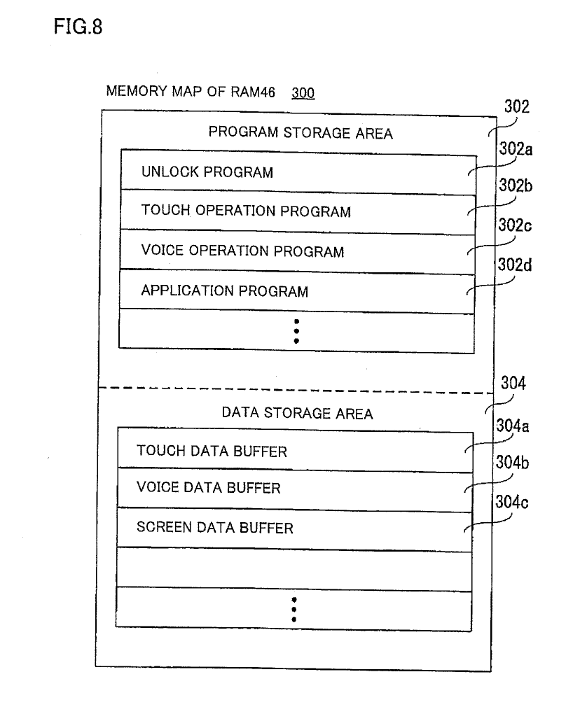

Referring to FIG. 8, RAM 46 can include a program storage area 302 and a data storage area 304. Program storage area 302 includes an area in which part or whole of program data preset in flash memory 44 (FIG. 2) is read and stored (developed), as described previously.

Program storage area 302 can store basic programs (not shown), such as an OS (Operating System) and a communication program necessary for a mobile phone (a program for making a phone call with another phone and making a data communication with another phone or computer).

Program storage area 302 can store programs, such as an unlock program 302a, a touch operation program 302b, a voice operation program 302c, and an application program 302d, as control programs.

Unlock program 302a includes a program for displaying the lock screen as shown in FIG. 3 to cancel the locked state by a touch input or a voice input. Touch operation program 302b is a program for operating an object by a touch input. Voice operation program 302c includes a program for operating an object by a voice input.

Application program 302d has been installed in mobile phone 10. Application program 302d includes various types of application programs indicated by the objects displayed in function display section 106 in FIG. 4, for example. Application program 302d includes a program for executing the function of each object in cooperation with touch operation program 302b or voice operation program 302c. Touch operation program 302b and voice operation program 302c each include a program to be executed in the application program when necessary.

Voice operation program 302c has a function of adding readable marks 108 (FIG. 4), 114a to 104c (FIG. 5), 120a to 120d (FIG. 6) or the like to objects which require readable marks, such as objects not accompanied by readable words. Voice operation program 302c can also determine whether there is a readable word or readable mark corresponding to a voice input through microphone 22 among readable words or readable marks of objects displayed on touchscreen 18.

Touch operation program 302b can determine whether touch coordinates shown by a touch input indicate an object displayed on touchscreen 18 (whether each object is touched).

A touch data buffer 304a, a voice data buffer 304b, a screen data buffer 304c, and the like are secured in data storage area 304 of RAM 46.

Touch data buffer 304a can temporarily store data on touch coordinates output from touch panel control circuit 48. Voice data buffer 304b can temporarily store data on a voice, obtained by processor 30, input by a user through microphone 22. Screen data buffer 304c can temporarily store readable words or readable marks given to objects currently displayed on touchscreen 18, as well as audio data, coordinate position data and the like indicating which objects are accompanied by those readable words or readable marks, each time the display of touchscreen 18 is changed.

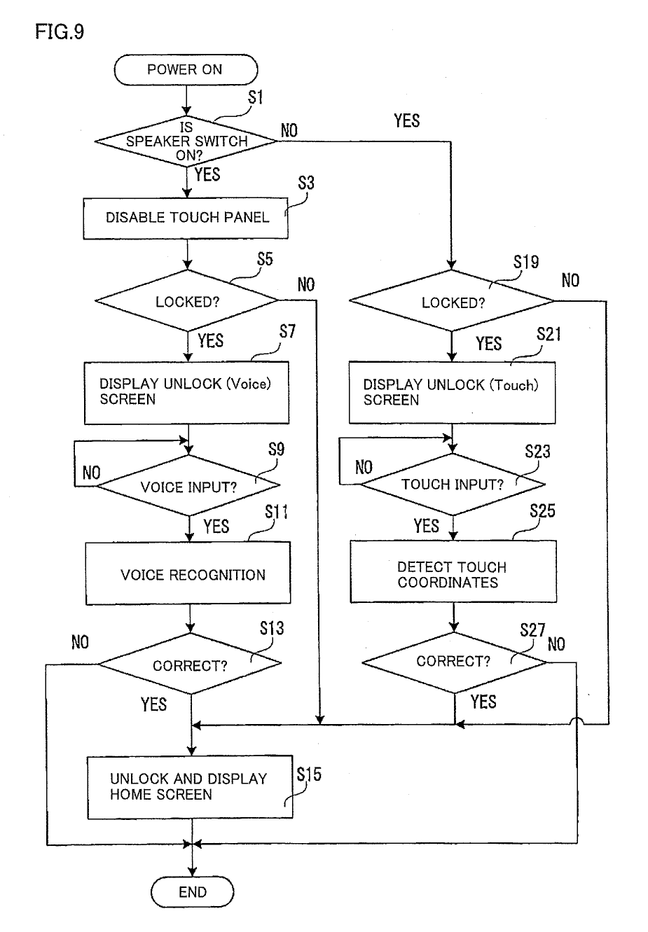

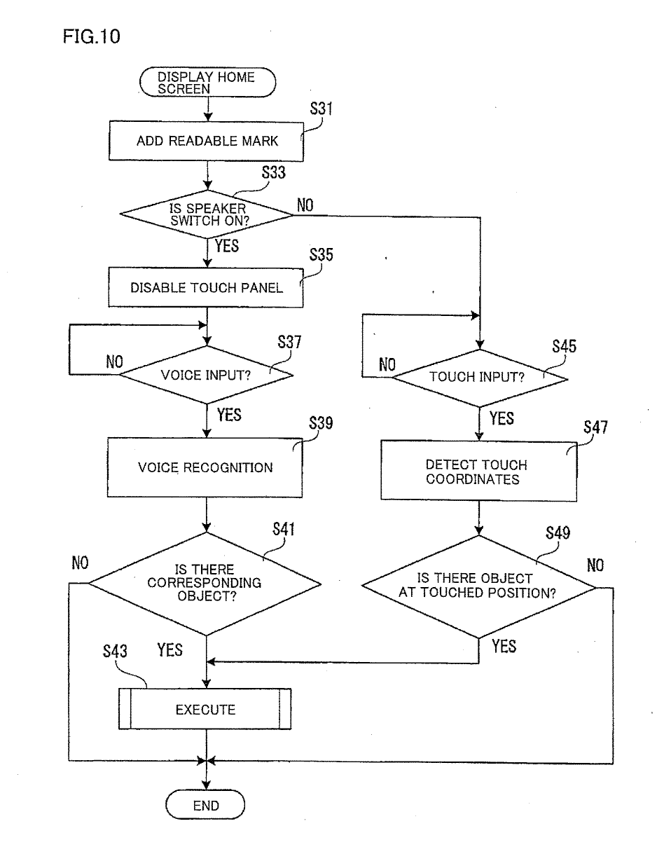

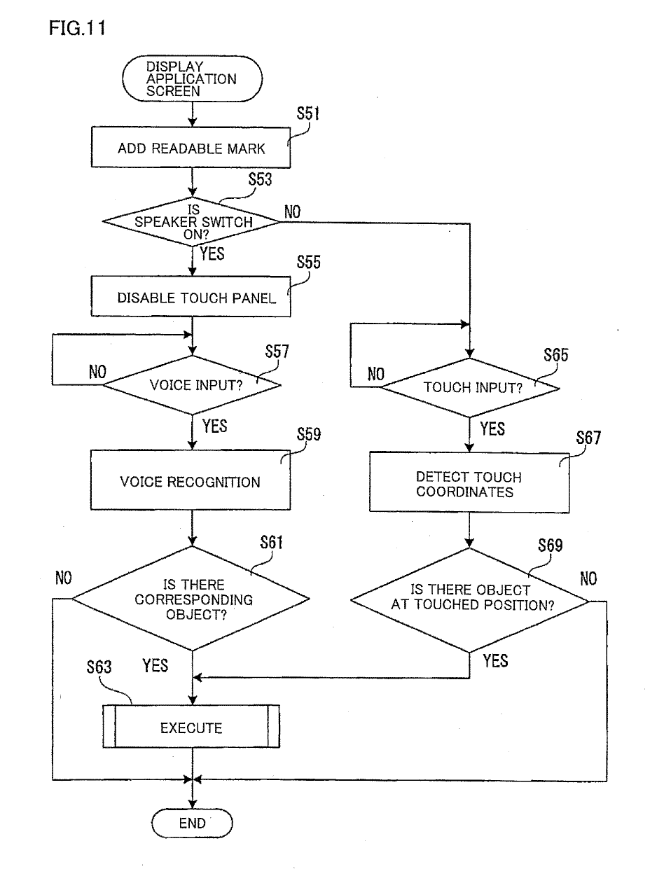

Processor 30 can process in parallel a plurality of tasks that can perform an unlock process shown in FIG. 9, application processes shown in FIGS. 10 and 11, and the like under control of a Windows® OS or another OS, such as a Linux® OS including Android™ and iOS®.

When power key 24g of mobile phone 10 is turned on, the process for unlocking shown in FIG. 9 can be executed. This flowchart of FIG. 9 can be executed at a relatively short interval (e.g., frame period) similarly to flowcharts shown in FIGS. 10 and 11.

In first step S1 in FIG. 9, processor 30 can determine whether a specific key among keys 24a to 24f and 24h shown in FIG. 1 has been pressed. In an embodiment, processor 30 can determine whether speaker switch key 24d has been pressed. When key 24d has been pressed (“YES” in step S1), processor 30 can disable touch panel 16 for setting a voice operation mode in step S3. Processor 30 can forbid an operation by a touch input.

In next step S5, processor 30 can determine whether mobile phone 10 is in the locked state. Processor 30 can determine whether it is in the locked state by checking an appropriate flag.

If speaker switch key 24d is being continuously pressed when the locked state has been set (“YES” in step S5), processor 30 can cause screen 100 for unlocking by a voice input shown in FIG. 3 to be displayed, for example, in next step S7.

In step S9, processor 30 can wait for a user to input a voice through microphone 22. If there is a voice input, audio data based on the voice input can be temporarily stored in voice data buffer 304b (FIG. 8). The user can input a voice through microphone 22 while pressing key 24d. When key 24d is released by the time when a voice is input through microphone 22 in step S9, the process can be terminated at that time, and the operation mode can transition to a touch operation mode.

In next step S11, processor 30 can execute a voice recognition process using the audio data. Processor 30 can check the contents of the voice input by the user at that time.

In step S13, processor 30 can determine whether the voice input identified as a result of voice recognition corresponds to a preset voice. In an embodiment, processor 30 can determine whether a correct voice input for unlocking has been made by determining whether the voice input corresponds to “Smart Device” as described above.

When it is determined that a correct voice input for unlocking has been made (YES in step S13), in step S15 processor 30 can cancel the locked state and can cause home screen 102 as shown in FIG. 4, for example, to be displayed.

When the voice input is not a correct voice input (NO in step S13), processor 30 can terminate the unlock process without cancelling the locked state. When it is determined “NO” in step S13, a message which prompts for a voice input again may be output through speaker 20 (FIG. 1) to permit re-entry.

When it is determined “NO” in step S5, processor 30 can assume that the locked state has not been set and proceed to step S15 maintaining the voice operation mode.

When the voice operation mode has not been set (“NO” in step S1), processor 30 can determine whether the locked state has been set in step S19 without disabling touch panel 16. When the locked state has been set (YES in step S19), processor 30 can execute the unlock process by a usual touch operation. When the locked state has not been set (NO in step S19), processor 30 can proceed to step S15 in the touch operation mode.

When it is determined “YES” in step S19, processor 30 can cause a lock screen (not shown) for a touch operation to be displayed in step S21. Since various methods for unlocking by a touch operation have been proposed, a specific lock screen will not be illustrated.

When a touch input is made in step S23 with the lock screen for a touch operation being displayed, touch coordinate data can be temporarily stored in touch data buffer 304a (FIG. 8) in step S25.

In step S27, processor 30 can determine whether the touch coordinate data corresponds to preset touch coordinate data for unlocking.

When it is determined that a correct touch input for unlocking has been made (YES in step S27), processor 30 can cancel the locked state and cause home screen 102 to be displayed in previous step S15.

When a touch input is not a correct touch input (NO in step S27), processor 30 can terminate the unlock process without cancelling the locked state. When it is determined “NO” in step S27, a message which prompts for a touch input again may be displayed on touchscreen 18 to permit re-entry.

In an embodiment, the locked state can be cancelled by a touch operation or voice operation. When the locked state is cancelled and home screen 102 shown in FIG. 4 is displayed, processor 30 can select a menu in accordance with the flowchart shown in FIG. 10.

In first step S31 in FIG. 10, processor 30 can refer to screen data on the home screen stored in screen data buffer 304c to determine whether there is any object on the home screen which requires a readable mark, such as an object not accompanied by a readable character. When there is an object which requires a readable mark (YES in step S31), readable mark 108 shown in FIG. 4 can be added to that object.

In step S33, processor 30 can determine whether speaker switch key 24d has been pressed. When key 24d has been pressed (YES in step S33), processor 30 can disenable touch panel 16 in step S35 for setting a voice operation mode.

When it is determined that speaker switch key 24d has been pressed (YES in step S33), readable mark 108 may be added. Step S31 may be performed after it is determined YES in step S33.

Subsequently, in steps S37 and S39, processor 30 can perform voice recognition of a voice input by a user through microphone 22 while pressing key 24d, similarly to previous steps S9 and S11.

Based on the voice recognized in step S39, processor 30 can determine in step S41 whether there is an object corresponding to the voice on the home screen (which object on the home screen is indicated by the user's voice input).

When there is a corresponding object (YES in step S41), processor 30 can execute a function indicated by that object in step S43. When a specific application has been selected, for example, processor 30 can cause a screen (application screen) for executing that application to be displayed.

When it is determined “NO” in step S41, display of the home screen can be maintained as it is.

When it is determined “NO” in step S33, a touch operation mode can be set. In steps S45 and S47, processor 30 can detect touch coordinates. In step S49, processor 30 can refer to the screen data to determine whether the touch coordinates indicate any of objects. Processor 30 can determine whether there is any object at a touched position.

When there is a corresponding object (YES in step S49), processor 30 can execute a function indicated by that object in step S43. When a specific application has been selected, for example, processor 30 can cause a screen (application screen) for executing that application to be displayed.

When it is determined “NO” in step S49, display of the home screen can be maintained as it is.

According to an embodiment, each object (touchable object) on the home screen which can be operated by a touch input can be directly indicated by a voice input. As opposed to the case of inputting a directive (request sentence) by voice, an object can be reliably operated.

When application screen 110 (FIG. 5) transitions to application screen 116 (FIG. 6), processor 30 can operate in accordance with the flowchart shown in FIG. 11. Since respective steps S51 to S69 in FIG. 11 are substantially similar to steps S31 to S49 in FIG. 10 in terms of the operation of processor 30 except objects being displayed, repeated description will not be given.

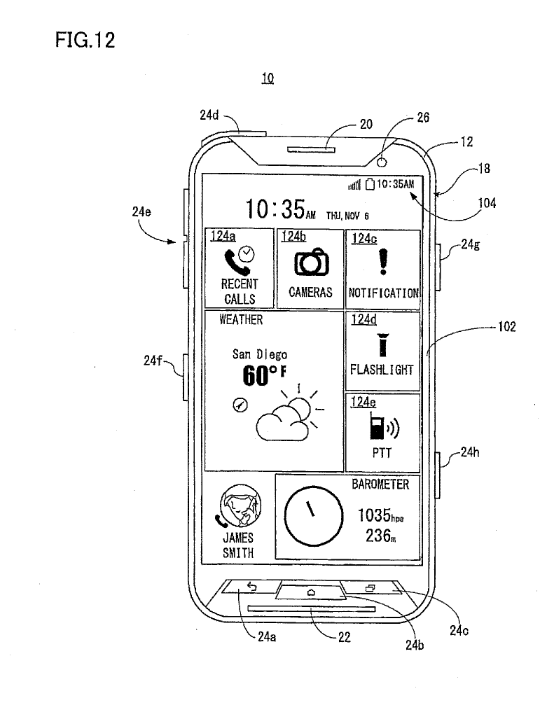

FIG. 12 shows another example of the home screen after performing unlocking on the lock screen of FIG. 3 in accordance with the flowchart in FIG. 9. On home screen 102 in FIG. 12, objects 124a to 124e, all of which are accompanied by readable words, are displayed on touchscreen 18.

Object 124a is accompanied by a readable word “RECENT CALLS.” Object 124a includes an object for displaying calls made recently. Object 124b includes an object for using the camera. Object 124b can be accompanied by a readable word “CAMERA.”

Object 124c includes an object indicating a matter to be notified. Object 124c can be accompanied by a readable word “NOTIFICATION.” Object 124d includes an object for using a white LED (Light Emitting Diode) (not shown) included in mobile phone 10 as a flash. Object 124d can be accompanied by a readable word “FLASHLIGHT.” Object 124e includes an object for using PTT (Push-To-Talk). Object 124e can be accompanied by a readable word “PTT.”

When all of objects being displayed on touchscreen 18 are originally accompanied by readable words as in home screen 102 of FIG. 12, it is not necessary to add readable marks prepared separately.

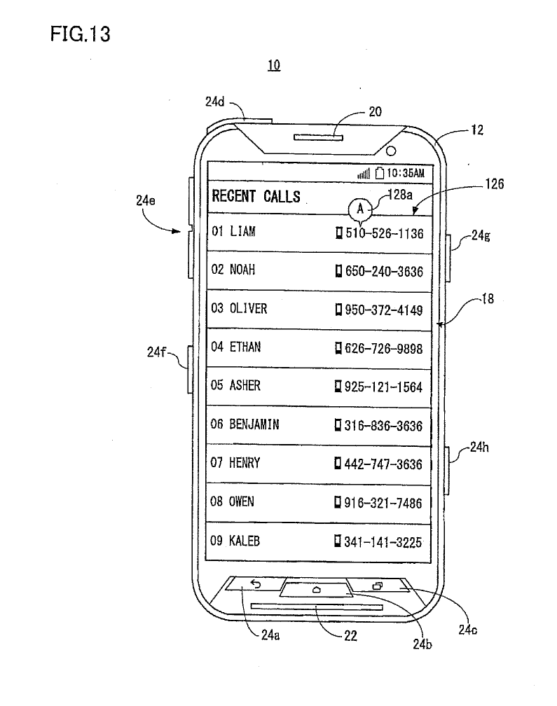

In the case of information necessary to be kept secret, such as a telephone number, an object corresponding to the information may be accompanied by an abstract readable mark even if the object is readable. For example, FIG. 13 shows an application screen 126 when object 124a is indicated by a voice input or a touch input on home screen 102 in FIG. 12. In FIG. 13, an object 126 indicating the telephone number at the top, for example, can be accompanied by a readable mark 128a. When a user makes a voice input, he/she only needs to make a voice input “A” for readable mark 128a without the need to read the telephone number aloud.

According to an embodiment, since a touchable object displayed on the touchscreen is operated by a voice input as described above, the object can be operated reliably similarly to the case of operating the touchable object by a touch input.

In an embodiment, when a touchable object includes a readable word, processor 30 can determine whether the voice corresponds to the readable word.

In an embodiment, when an object includes a readable word or is displayed together with a readable word, processor 30 can determine whether the input voice corresponds to the readable word included in the object or displayed in connection with the object.

According to an embodiment, most objects can include readable words or can be displayed on the touchscreen together with the readable words. By adding the function relevant to a voice input, a reliable operation on an object can be achieved.

In an embodiment, processor 30 can add a readable mark including a readable word to a touchable object. Processor 30 can determine whether the voice corresponds to the readable word included in the readable mark.

In an embodiment, processor 30 can add a readable mark (108, 114a to 114c, etc.) to an object not including a readable word or an object not displayed together with a readable word, or an object which would invade privacy if read aloud in public. Processor 30 can determine whether the input voice corresponds to the readable word included in the readable mark.

According to an embodiment, even if an object does not include a readable word, for example, the object can be reliably operated by a voice input by adding a readable mark thereto.

In an embodiment, processor 30 can determine whether a recognized voice corresponds to a correct voice for unlocking with the lock screen being displayed. When it is determined that the voice corresponds to the correct voice for unlocking, processor 30 can cancel the locked state.

In an embodiment, processor 30 can determine whether the voice recognized by processor 30 is a correct voice for unlocking (e.g., “Smart Device”) with speaker switch key 24d, for example, being continuously pressed. When it is determined that the voice corresponds to the correct voice for unlocking, processor 30 can cancel the locked state to cause the home screen, for example, to be displayed.

According to an embodiment, the locked state can be cancelled by a voice input.

In an embodiment, a specific mode can be set in response to an operation on a specific hardware key.

In an embodiment, a specific mode of operating a touchable object by a voice input can be set by operating a specific key, such as speaker switch key 24d.

According to an embodiment, a specific mode can be easily set by operating a specific key.

The specific screen described in an embodiment is merely for illustration, and an embodiment can be applied to a home screen or an application screen having any design.

In any embodiment described above, since the voice operation mode is executed by continuously pressing a specific key (e.g., speaker switch key 24d), touch panel 16 is disabled (steps S3, S35, S65). It is optional whether to disable touch panel 16. Transition may be made to the voice operation mode with touch panel 16 being effective.

When there is a letter with the same reading as a readable mark among letters displayed on the touchscreen, for example, when an object “A” is displayed on the touchscreen in addition to the readable mark “A”, and when a user inputs the reading (A) by voice, a message asking that “Is it A of a readable mark?”, for example, and alternatives of “yes” and “no” may be displayed on the touchscreen. A user may say “yes” for inputting readable mark A by voice, and say “no” for inputting the other “A” by voice.

Processor 30 can exert control such that objects with the same reading are not displayed on the touchscreen.

In an embodiment, a voice input can be made while speaker switch key 24d is being pressed. When speaker switch key 24d is pressed in the state where a voice input cannot be made (touch input mode), a voice input can be made. When speaker switch key 24d is pressed in the state where a voice input can be made (voice input mode), a voice input may become impossible. By pressing speaker switch key 24d, the input mode may be switched between the touch input mode and the voice input mode.

In the above-described embodiment, a specific mode (in an embodiment, the voice input mode in which a touchable object can be operated by a voice input) is set when a specific key such as speaker switch key 24d is operated, but the method of setting such a specific mode is not limited to the method of an embodiment.

In the above-described embodiment, speaker switch key 24d is used as the specific key, but this may be replaced by another key except power key 24g.

The program used in an embodiment may be stored in a HDD (Hard Disc Drive) of a data distribution server, and may be distributed to mobile phone 10 over a network. A storage medium, such as an optical disk including a CD (Compact Disc), a DVD (Digital Versatile Disc) and a BD (Blu-Ray Disc), a USB (Universal Serial Bus) memory, and a memory card, with a plurality of programs stored therein, may be sold or distributed. When a program downloaded through the above-described server, storage medium or the like is installed in a mobile phone having a configuration equivalent to that of an embodiment, effects equivalent to those of an embodiment are obtained.

In the above-mentioned embodiment, an information processing terminal (10: it is illustration of a corresponding reference number in an embodiment: this shall apply hereinbelow) includes a microphone (22), a plurality of keys (24a-24h) including a power key, and a touchscreen (18). On the home screen or the application screen, touchable objects (106a-106i, 112a-112i, etc.) are displayed on the touchscreen (18). When any of these touchable objects is operated by a touch input, processor 30 (302d, S43, S63) can execute a function assigned to a touchable object operated by the touch input. For example, when a specific key such as the speaker switch key (24d) is continuously pressed, the voice operation mode is set. In the voice operation mode, when a user inputs a voice through the microphone (22), processor 30 (302c, S39, S59) can recognize the voice. When it is determined that the recognized voice indicates a touchable object, processor 30 (302c, S41, S61) can execute the function of the touchable object.

Although the present disclosure has been described and illustrated in detail, it is clearly understood that the same is by way of illustration and example only and is not to be taken by way of limitation, the scope of the present disclosure being interpreted by the terms of the appended claims.

1. An information processing terminal configured to set at least one of a first operation mode and a second operation mode as an operation mode, the information processing terminal comprising:
a microphone;
a touchscreen; and
at least one processor,
the at least one processor being configured to execute a function of a touchable object displayed on the touchscreen:
(i) when the touchable object is operated by a user in the first operation mode; and
(ii) when a voice input through the microphone indicates the touchable object in the second operation mode.

2. The information processing terminal according to claim 1, wherein, when the touchable object includes a readable word, the at least one processor is configured to determine whether the voice corresponds to the readable word.

3. The information processing terminal according to claim 1, wherein the at least one processor is configured to:
add a mark including a readable word to the touchable object; and
determine whether the voice corresponds to the readable word.

4. The information processing terminal according to claim 1, further comprising a plurality of keys, wherein
in the second operation mode, when the information processing terminal is in a locked state of not accepting an operation other than an operation on a specific key included in the plurality of keys and when a lock screen is displayed on the touchscreen, the at least one processor is configured to cancel the locked state if the voice corresponds to a predetermined voice for canceling the locked state.

5. The information processing terminal according to claim 1, further comprising a plurality of keys, wherein
the second operation mode is set in response to an operation on a specific key included in the plurality of keys.

6. An information processing method executed by a processor included in an information processing terminal configured to set at least one of a first operation mode and a second operation mode as an operation mode,
the information processing terminal comprising:
a microphone;
a touchscreen; and
at least one processor configured to execute a function of a touchable object displayed on the touchscreen when the touchable object is operated by a user in the first operation mode,
in the second operation mode, the information processing method comprising:
recognizing a voice input through the microphone;
determining whether the voice indicates the touchable object; and
executing the function of the touchable object when it is determined that the voice indicates the touchable object.

7. A processor-readable non-transitory recording medium with a program recorded thereon, the program causing a processor to execute an information processing method, the processor being included in an information processing terminal configured to set at least one of a first operation mode and a second operation mode as an operation mode,
the information processing terminal comprising:
a microphone;
a touchscreen; and
at least one processor configured to execute a function of a touchable object displayed on the touchscreen when the touchable object is operated by a user in the first operation mode,
in the second operation mode, the information processing method comprising:
recognizing a voice input through the microphone;
determining whether the voice indicates the touchable object; and
executing the function of the touchable object when it is determined that the voice indicates the touchable object.
